(19) United States
(12) Patent Application Publication
(10) Pub. No.: US 2013/0028644 A1
(43) Pub. Date: Jan. 31, 2013

(54) ELECTROPHOTOGRAPHIC PRINTER AND CLEANING SYSTEM WITH SCRAPER CLEANING SYSTEM

(71) Applicants: Michael Thomas Dobbertin, Honeoye, NY (US); Francisco Luiz Ziegelmuller, Penfield, NY (US); James Douglas Shifley, Spencerport, NY (US); Jean Marie Trost, Rochester, NY (US); James N. Alkins, Holley, NY (US)

(72) Inventors: Michael Thomas Dobbertin, Honeoye, NY (US); Francisco Luiz Ziegelmuller, Penfield, NY (US); James Douglas Shifley, Spencerport, NY (US); Jean Marie Trost, Rochester, NY (US); James N. Alkins, Holley, NY (US)

(21) Appl. No.: 13/193,671

(22) Filed: Jul. 29, 2011

(51) Int. Cl. G03G 21/00

(52) U.S. Cl. 399/351

(57) ABSTRACT

Electrophotographic printers and cleaning systems for an electrostatic imaging member are provided. In one aspect the cleaning system has a scraper a mounting holding the scraper so that a free length of the scraper extends from the mounting and a frame positioning the mounting relative to the electrostatic imaging member so that the scraper extends along a holding angle toward the electrostatic imaging member and so that the mounting is separated from the electrostatic imaging member by an extension distance along the holding angle that is less than the free length with the scraper resiliently deflecting to fit within the extension distance to define a working angle where the scraper contacts the electrostatic imaging member. The extension distance is within a range of extension distances that cause the scraper to have a working angle that is within a range of working angles are greater than the working angles of an alternative range of working angles if the scraper were to be positioned within an alternative range of extension distances that is greater than the range of extension distances.

### CROSS REFERENCE TO RELATED APPLICATIONS

This application relates to commonly assigned, copending U.S. application Ser. No. 13/037,632, filed Mar. 1, 2011, entitled: “ELECTROPHOTOGRAPHIC PRINTER AND CLEANING SYSTEM” which is hereby incorporated by reference.

### FIELD OF THE INVENTION

This invention relates to the field of electrophotographic printing, and in particular, cleaning systems used in electrophotographic printers.

### BACKGROUND OF THE INVENTION

In a typical electrophotographic printer, a latent image charge pattern is formed on an electrostatic imaging member in accordance with an image to be printed and the electrostatic image is developed with charged toner particles. The charged toner particles adhere to the latent image charge pattern on the electrostatic imaging member to form a toner image. The toner image is then transferred from the electrostatic imaging member to a transfer subsystem and from the transfer subsystem to a receiver. The toner and receiver are then fused to form a print.

In certain circumstances, less than all of the toner forming the toner image transfers from the electrostatic imaging member to the transfer system. This leaves residual toner on the electrostatic imaging member that can create unwanted artifacts in subsequent toner images formed on the electrostatic imaging member. Additionally, other material such as fuser oil, coatings and fragments of toner particles, agglomerates, carrier, paper fibers, paper coatings, dirt, dust and other charged materials in the environment surrounding the printer can be attracted to and can accumulate on the electrostatic imaging member to form a layer. This layer can be difficult to remove and can also cause unwanted artifacts in subsequent toner images formed on the electrostatic imaging member. Accordingly, electrostatic primary imaging members are typically cleaned between or within image printing cycles to remove any such residual toner and other material (referred to herein collectively as “residual material”).

Various techniques have been developed to clean electrostatic imaging members. In some devices, magnetic or electrically biased members are used to attract residual material from an electrostatic imaging member (see for example U.S. Pat. No. 4,639,124 issued to Nye, Jr. et al. on Jan. 27, 1987.) In other devices, cleaning is performed using a fabric or other type of contact brush (see for example U.S. Pat. No. 4,999,679 issued to Corbin et al. on Mar. 12, 1991). Such brushing techniques, while generally effective at removing residual toner have proven less effective at removing the other types of residual material.

Accordingly, other types of cleaning systems have been developed to try to remove such residual material. One type of cleaning system is a scraping system in which a blade is held with a working face that extends toward an electrostatic imaging member in a direction that opposes the direction of movement of the electrostatic imaging member. In such systems, residual material is scraped from the electrostatic imaging member as the electrostatic imaging member is moved past the blade.

One example of a scraping system is U.S. Pat. No. 3,947,108 issued to Thettu et al. on Mar. 30, 1976. In the '108 patent, a blade is shown that oscillates back and forth across a drum during cleaning. The blade has a leading edge in contact with a surface of the drum. The blade is positioned so that the blade extends toward the drum in a direction opposite to a direction of drum rotation to shear material from the face of the drum. However, in the '108 patent, the blade is used to remove residual toner particles so as make a secondary brush cleaner more efficient at removing a film of other material from the drum.

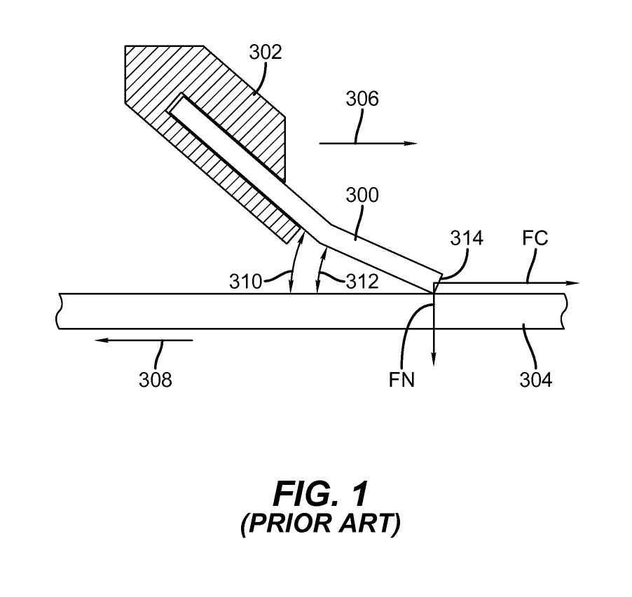

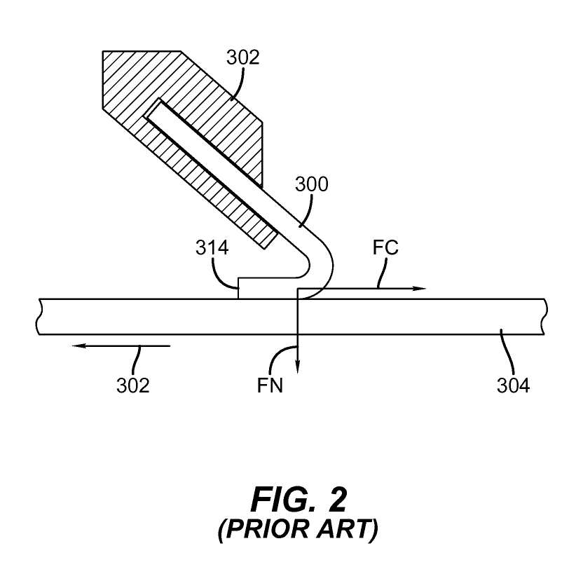

In U.S. Pat. No. 4,989,047 issued to Jugle et al. on Jan. 29, 1991, a thin scraper member is provided as a secondary cleaner to remove agglomerations of toner and debris from an electrostatic imaging member after a cleaning brush has had an opportunity to clean the electrostatic imaging member. FIG. 1, which is adapted from FIG. 2B of the '047 patent, shows one embodiment of a thin scraper 300 that extends from a holder 302 toward an electrostatic imaging member 304 in a direction 306 that is the opposite of a direction of movement 308 of the electrostatic imaging member 304. As is also shown in FIG. 1 scraper 304 extends from holder 302 at a first angle 310 and contacts electrostatic imaging member 310 at a shallow working angle 312. This approach advantageously allows scraper 310 to provide a substantial amount of cleaning force FC against any residual materials on electrostatic imaging member 310 while applying only a limited amount of normal force FN against electrostatic imaging member 310. A very low scraping angle is used, for example between just over 0 and up to 9 degrees and a load is applied to help keep the scraping blade against the surface being cleaned.

However, scraping systems are subject to a failure mode known as blade tuck or “tuck under”. FIG. 2 shows an example of this condition in the context of the scraper shown in FIG. 1. As is shown in FIG. 2, a blade tuck occurs when a leading edge 314 of a scraper 300 folds under scraper 300. Blade “tuck” can happen because, for example, the frictional force between leading edge 314 and electrostatic imaging surface 304 reaches a high enough level to cause leading edge 314 to move with electrostatic imaging member 304.

A tucked under scraper 300 creates a normal force FN against the electrostatic imaging member 304 that can be substantially greater than the normal force FN of scraper 300 in a normal state and provides substantially reduced cleaning force FC. This can create wear marks and scratches on the electrostatic imaging member 304, reduce the useful life of scraper 300 and the electrostatic imaging member 304 as well as interrupting work flow and wasting consumables.

In embodiments described in the '047 patent the blades are mounted in a movable mountings that allow the scraping blades to be moved in the vertical direction and a low load is placed on the blades so that a maximum shearing force can be applied by the blade. This is done to avoid the problems associated with normal cleaning engagement of blades with a charge retentive surface. According to the '047 patent, because of the low load of the blade, the minimal amount of toner that normally passes through any cleaning system serves as a lubricant for the blade without the need for further added lubricant.

U.S. Pat. No. 5,031,000, issued to Pozniakas et al. which is a continuation in part from the application leading to the '047 patent, provides claims that are directed to a blade supported in a floating support assembly. The blade floats under a low weight during break in of a new blade to prevent tuck under and damage to the blade. The weight applied to the blade is optimized for the break in period and the support assembly has a stop to prevent blade creep during normal operations.

U.S. Pat. No. 5,349,428, issued to Derrick on Sep. 20, 1994, also notes that the leading edges of scraping blades are subject to a failure mode known as blade “tuck”. The '428 patent proposed to solve this problem using a variable position drum.

Because scrapers oppose the direction of motion of the electrostatic imaging member another problem that can arise with the use of a scraper is the so called “chatter” problem. Chatter occurs because the coefficient of static friction between the scraper and the electrostatic imaging member is greater than the coefficient of dynamic friction between the scraper and the electrostatic imaging member. Accordingly, when movement of the electrostatic imaging member is slow the coefficient of static friction can cause the scraper to deflect in the direction of motion of the electrostatic imaging member until sufficient elastic energy is stored in the scraper to allow the scraper to overcome the static friction causing rapid movement of the cleaning edge of the scraper. This rapid movement reduces cleaning efficiency and creates bands of uncleaned or partially cleaned areas on the electrostatic imaging member.

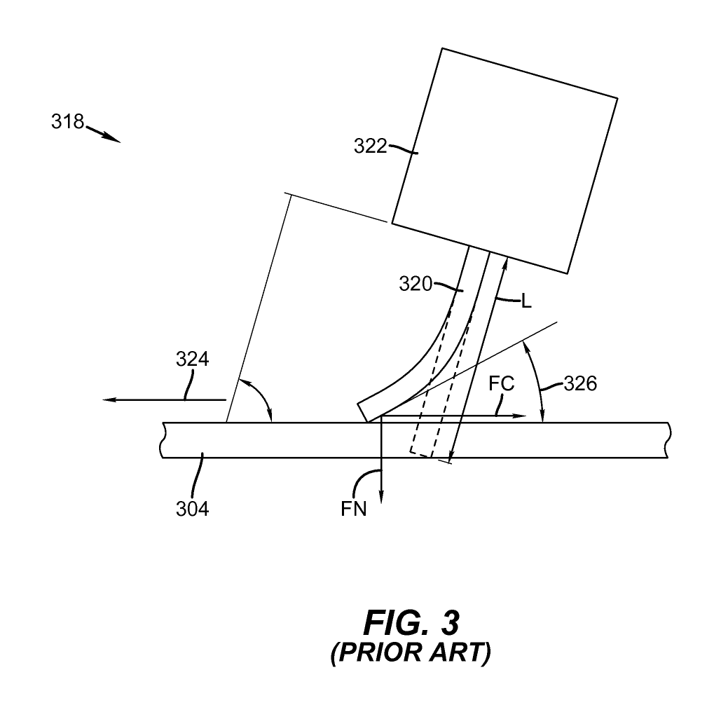

Alternatively it has been known to clean an electrostatic imaging member using a wiper. FIG. 3 illustrates one example of a wiper type cleaning system 318. In this example, wiper 320 is held by a holder 322. Holder 233 extends toward electrostatic imaging member 304 in a direction 324 of movement of electrostatic imaging member 304. Because such wipers extend toward the electrostatic imaging member 304 in the direction of movement of the electrostatic imaging member, wiper type cleaning systems are not subject to the blade “tuck” failure mode that occurs with scrapers. Wiper cleaning systems 318 however have working angles 326 that are higher than the working angles used in scraper systems. For this reason wiper cleaning systems 318 typically apply a greater amount of normal force FN against the electrostatic imaging member 304 being cleaned to achieve a desired cleaning force FC than do scraper systems. This can increase the amount of friction acting on an electrostatic imaging member 304 and can impact the useful life of the electrostatic imaging member 304 and wiper 320. Such results can become particularly pronounced where a high cleaning force FC is required.

The working angle 326 of the wiper 320 is established as a function of holding angle 328 at which wiper 320 is held and the free length L of wiper 320 when unbent (shown in phantom in FIG. 3), and a variety of factors including the separation distance 325 between holder 322 and electrostatic imaging member 304. Ultimately, the holding angle 328 determines the highest possible working angle 328 for a wiper, with other factors controlling the extent to which the working angle 326 will deviate from holding angle 328.

It will be appreciated that in a wiping system such as wiping system 318 there can be variations in these factors and that wiping system 318 will be defined in a manner that provides a minimum cleaning force FC at all possible working angles 326 within the range of variability in these factors. This typically requires that wiping system 318 provides this minimum cleaning force FC over a wide range of working angles 326. When wiping system 318 is operated at low working angles 326 in the range, the amount of normal force FN that must be applied to the electrostatic imaging member 312 to achieve the minimum desired cleaning force FC increases significantly.

What is needed therefore is a cleaning solution that removes residual materials from an electrostatic imaging member and that also does so with limited normal force, reduced chatter and reduced risk of blade “tuck” incidents.

### SUMMARY OF THE INVENTION

Electrophotographic printers and cleaning systems for an electrostatic imaging member are provided. In one aspect the cleaning system has a scraper a mounting holding the scraper so that a free length of the scraper extends from the mounting and a frame positioning the mounting relative to the electrostatic imaging member so that the scraper extends along a holding angle toward the electrostatic imaging member and so that the mounting is separated from the electrostatic imaging member by an extension distance along the holding angle that is less than the free length with the scraper resiliently deflecting to fit within the extension distance to define a working angle where the scraper contacts the electrostatic imaging member. The extension distance is within a range of extension distances that cause the scraper to have a working angle that is within a range of working angles are greater than the working angles of an alternative range of working angles if the scraper were to be positioned within an alternative range of extension distances that is greater than the range of extension distances.

### DETAILED DESCRIPTION OF THE DRAWINGS

FIG. 1 shows one example of a prior art scraper system.

FIG. 2 shows the example of FIG. 1 during a tuck under incident.

FIG. 3 shows one example of a prior art wiper system.

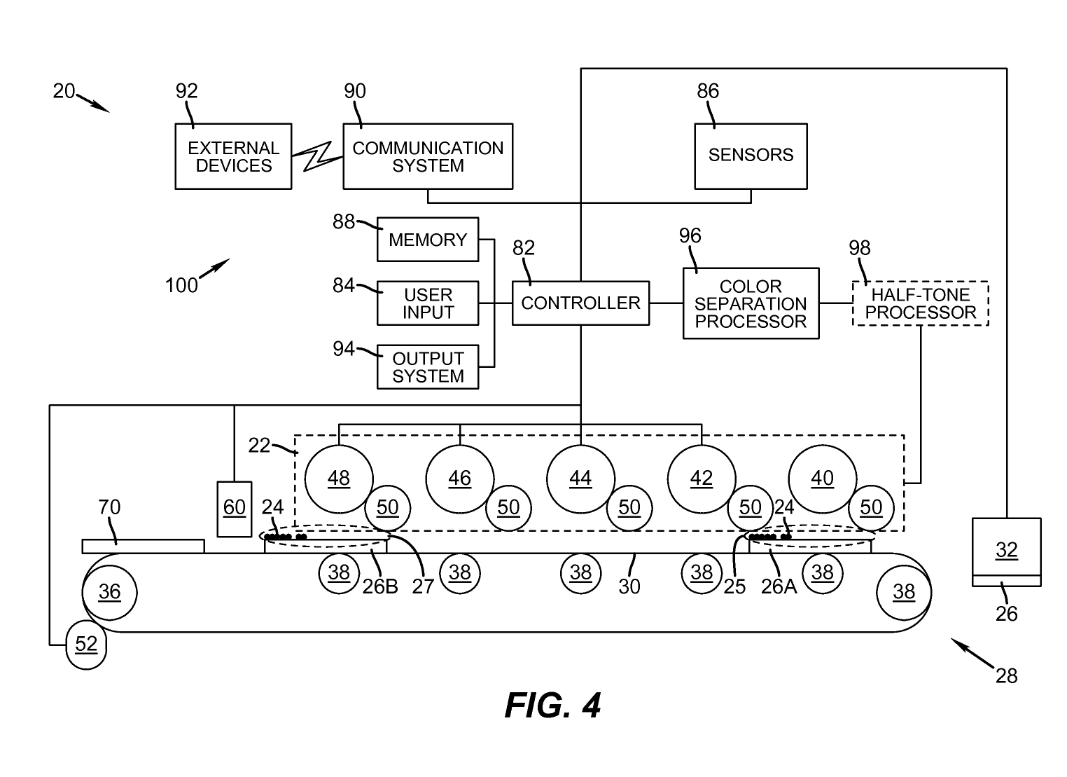

FIG. 4 shows a system level illustration of one embodiment of an electrophotographic printer.

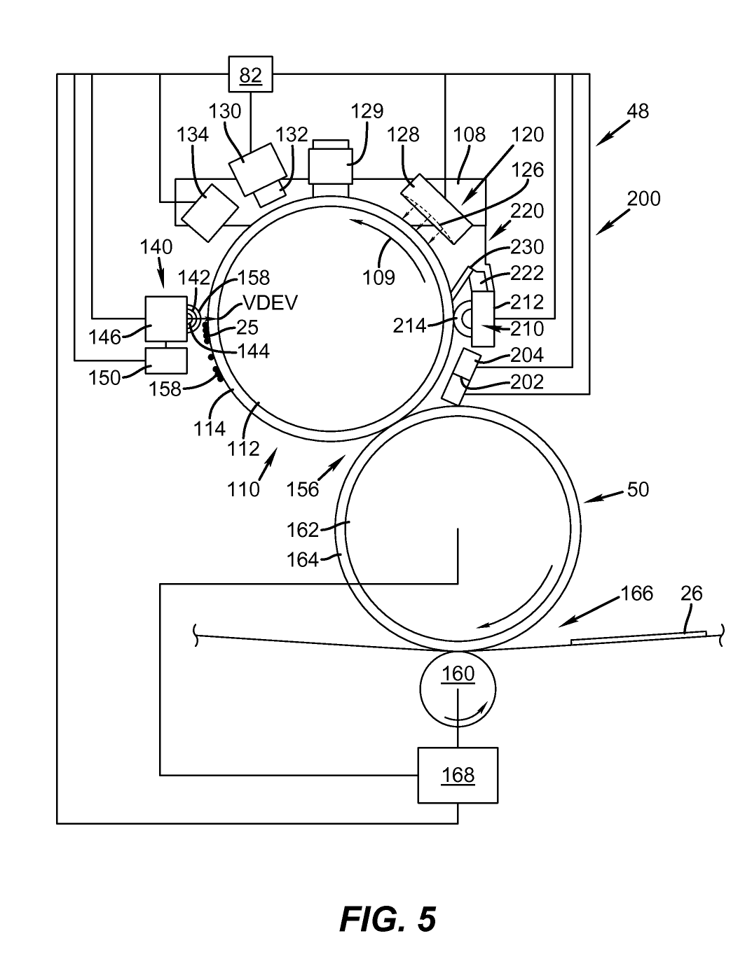

FIGS. 5, 6 and 7 illustrate a printing module during printing and cleaning operations.

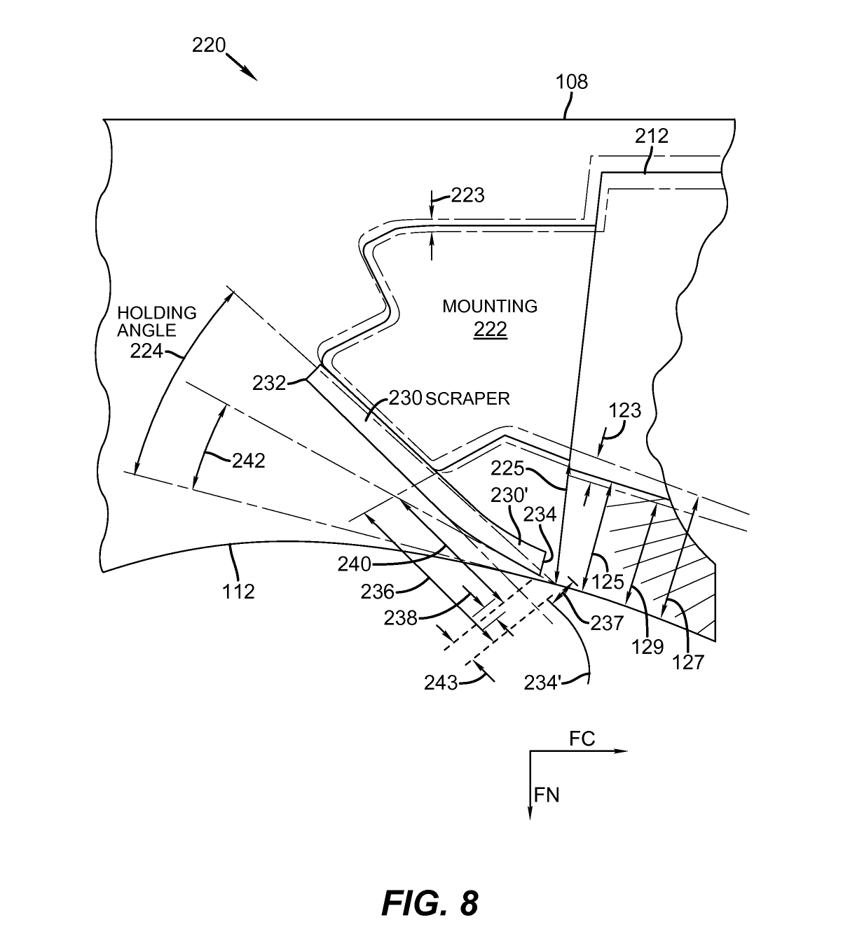

FIGS. 8, 9, and 10 show a scraper cleaning system in greater detail.

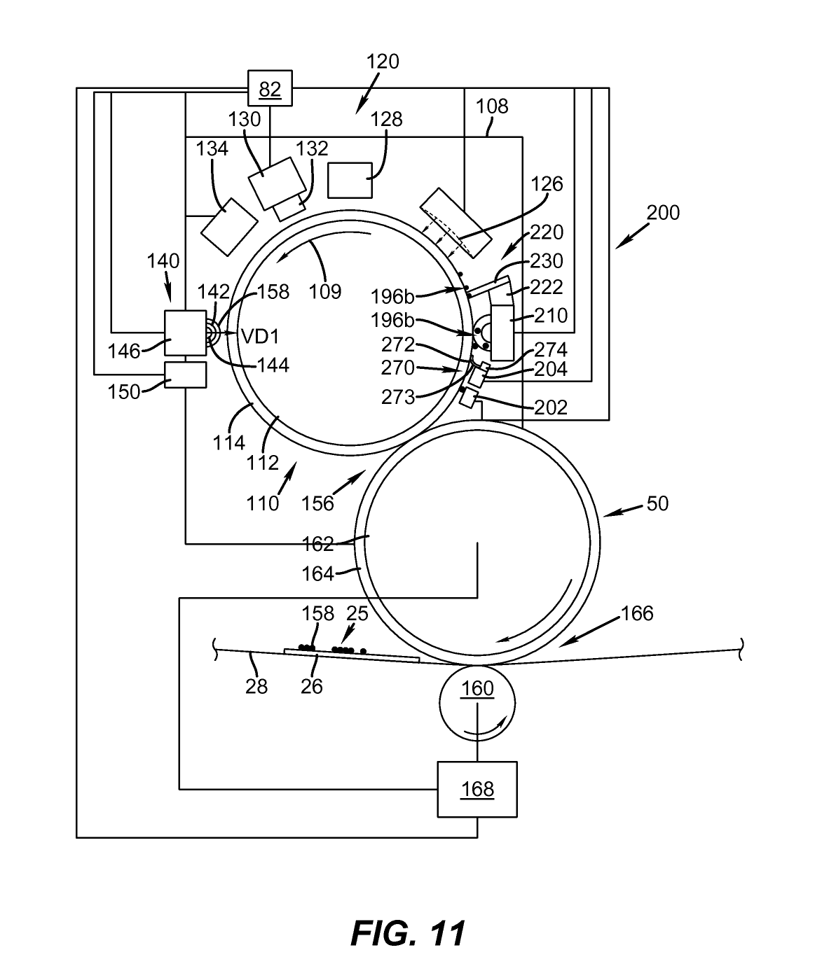

FIG. 11 shows an embodiment of a cleaning system with a trap system.

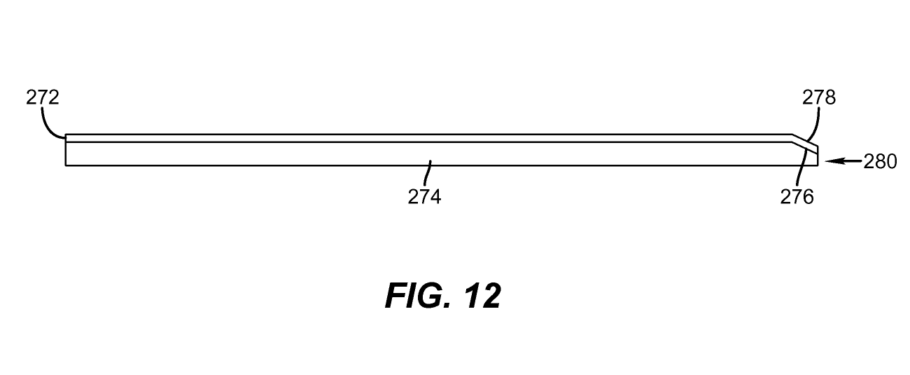

FIG. 12 shows a width of the trap system with tapered edges.

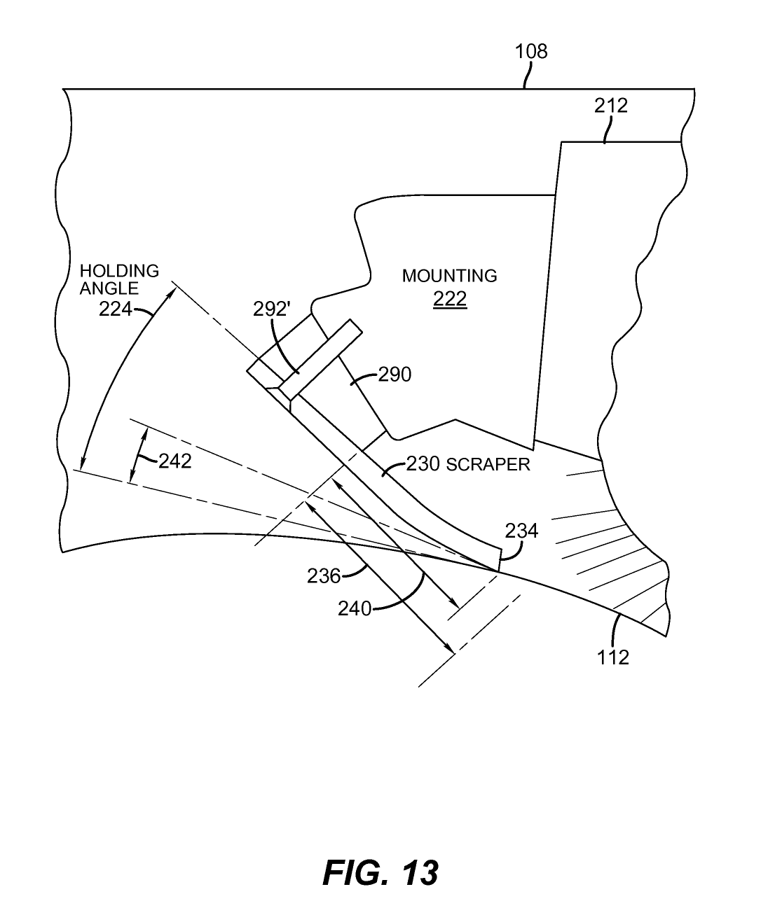

FIG. 13 shows an embodiment of a scraper system having a positioner

### DETAILED DESCRIPTION OF THE INVENTION

FIG. 4 is a system level illustration of a printer 20. In the embodiment of FIG. 4, printer 20 has a print engine 22 of an electrophotographic type that deposits toner 24 to form a toner image 25 in the form of a patterned arrangement of toner stacks. Toner image 25 can include any patternwise application of toner 24 and can be mapped according to data representing text, graphics, photo, and other types of visual content, as well as patterns that are determined based upon desirable structural or functional arrangements of the toner 24.

Toner 24 is a material or mixture that contains toner particles and that can form an image, pattern, or indicia when electrostatically deposited on an imaging member including a photoreceptor, photoconductor, electrostatically-charged, or magnetic surface. As used herein, “toner particles” are the particles that are electrostatically transferred by print engine 22 to form a pattern of material on a receiver 26 to convert an electrostatic latent image into a visible image or other pattern of toner 24 on receiver. Toner particles can also include clear particles that have the appearance of being transparent or that while being generally transparent impart a coloration or opacity. Such clear toner particles can provide for example a protective layer on an image or can be used to create other effects and properties on the image. The toner particles are fused or fixed to bind toner 24 to a receiver 26.

Toner particles can have a range of diameters, e.g. less than 4 on the order of 5-15 μm, up to approximately 30 μm, or larger. When referring to particles of toner 24, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner 24 is also referred to in the art as marking particles or dry ink. In certain embodiments, toner 24 can also comprise particles that are entrained in a liquid carrier.

Typically, receiver 26 takes the form of paper, film, fabric, metallicized or metallic sheets or webs. However, receiver 26 can take any number of forms and can comprise, in general, any article or structure that can be moved relative to print engine 22 and processed as described herein.

Print engine 22 has one or more printing modules, shown in FIG. 4as printing modules 40, 42, 44, 46, and 48 that are each used to deliver a single an application of toner 24 to form a toner image 25 on receiver 26. For example, the toner image 25 shown formed on receiver 26A in FIG. 4 can provide a monochrome image or layer of a structure or other functional material or shape.

Print engine 22 and a receiver transport system 28 cooperate to deliver one or more toner image 25 in registration to form a composite toner image 27 such as the one shown formed in FIG. 4. as being formed on receiver 26B. Composite toner image 27 can be used for any of a plurality of purposes, the most common of which is to provide a printed image with more than one color. For example, in a four color image, four toner images are formed each toner image having one of the four subtractive primary colors, cyan, magenta, yellow, and black. These four color toners can be combined to form a representative spectrum of colors. Similarly, in a five color image various combinations of any of five differently colored toners can be combined to form a color print on receiver 26. That is, any of the five colors of toner 24 can be combined with toner 24 of one or more of the other colors at a particular location on receiver 26 to form a color after a fusing or fixing process that is different than the colors of the toners 24 applied at that location.

In FIG. 4, print engine 22 is illustrated as having an optional arrangement of five printing modules 40, 42, 44, 46, and 48, also known as electrophotographic imaging subsystems arranged along a length of receiver transport system 28. Each printing module delivers a single toner image 25 to a respective transfer subsystem 50 in accordance with a desired pattern. The respective transfer subsystem 50 transfers the toner image 25 onto a receiver 26 as receiver 26 is moved by receiver transport system 28. Receiver transport system 28 comprises a movable surface 30 that positions receiver 26 relative to printing modules 40, 42, 44, 46, and 48. In this embodiment, movable surface 30 is illustrated in the form of an endless belt that is moved by motor 36, that is supported by rollers 38, and that is cleaned by a cleaning mechanism 52. However, in other embodiments receiver transport system 28 can take other forms and can be provided in segments that operate in different ways or that use different structures. In operation, printer controller 82 causes one or more of individual printing modules 40, 42, 44, 46 and 48 to generate a toner image 25 of a single color of toner for transfer by respective transfer subsystems 50 to receiver 26 in registration to form a composite toner image 27. In an alternate embodiment, not shown, printing modules 40, 42, 44, 46 and 48 can each deliver a single application of toner 24 to a composite transfer subsystem 50 to form a combination toner image thereon which can be transferred to a receiver.

Printer 20 is operated by a printer controller 82 that controls the operation of print engine 22 including but not limited to each of the respective printing modules 40, 42, 44, 46, and 48, receiver transport system 28, receiver supply 32, and transfer subsystem 50, to cooperate to form toner images 25 in registration on a receiver 26 or an intermediate in order to yield a composite toner image 27 on receiver 26 and to cause fuser 60 to fuse composite toner image 27 on receiver 26 to form a print 70 as described herein or otherwise known in the art.

Printer controller 82 operates printer 20 based upon input signals from a user input system 84, sensors 86, a memory 88 and a communication system 90. User input system 84 can comprise any form of transducer or other device capable of receiving an input from a user and converting this input into a form that can be used by printer controller 82. Sensors 86 can include contact, proximity, electromagnetic, magnetic, or optical sensors and other sensors known in the art that can be used to detect conditions in printer 20 or in the environment-surrounding printer 20 and to convert this information into a form that can be used by printer controller 82 in governing printing, fusing, finishing or other functions.

Memory 88 can comprise any form of conventionally known memory devices including but not limited to optical, magnetic or other movable media as well as semiconductor or other forms of electronic memory. Memory 88 can contain for example and without limitation image data, print order data, printing instructions, suitable tables and control software that can be used by printer controller 82.

Communication system 90 can comprise any form of circuit, system or transducer that can be used to send signals to or receive signals from memory 88 or external devices 92 that are separate from or separable from direct connection with printer controller 82. External devices 92 can comprise any type of electronic system that can generate signals bearing data that may be useful to printer controller 82 in operating printer 20.

Printer 20 further comprises an output system 94, such as a display, audio signal source or tactile signal generator or any other device that can be used to provide human perceptible signals by printer controller 82 to feedback, informational or other purposes.

Printer 20 prints images based upon print order information. Print order information can include image data for printing and printing instructions and can be generated locally at a printer 20 or can be received by printer 20 from any of variety of sources including memory system 88 or communication system 90. In the embodiment of printer 20 that is illustrated in FIG. 4, printer controller 82 has a color separation image processor 96 to convert the image data into one or more separation images. Each separation image define a pattern of a toner that is used by one of the printing modules 40-48 of print engine 22 and is sent to the printing module that will print using that toner. An optional half-tone processor 98 is also shown that can process the separation images according to any half-tone screening requirements of print engine 22.

FIGS. 5, 6 and 7 show more details of an example of a printing module 48 representative of printing modules 40, 42, 44, and 46 of FIG. 4. In this embodiment, printing module 48 has a frame 108, a primary imaging system 110, and a charging subsystem 120, a writing subsystem 130, a development station 140 and a cleaning system 200 that are each ultimately responsive to printer controller 82. Each printing module can also have its own respective local controller (not shown) or hardwired control circuits (not shown) to perform local control and feedback functions for an individual module or for a subset of the printing modules. Such local controllers or local hardwired control circuits are coupled to printer controller 82.

Primary imaging system 110 includes an electrostatic imaging member 112. In the embodiment of FIGS. 5, 6, and 7 electrostatic imaging member 112 takes the form of an imaging cylinder. However, in other embodiments, electrostatic imaging member 112 can take other forms, such as a belt or plate. As is indicated by arrow 109 in FIGS. 5, 6, and 7 electrostatic imaging member 112 is rotated directly or indirectly by an actuator such as a motor (not shown) such that electrostatic imaging member 112 rotates from charging subsystem 120, to writing subsystem 130 to development station 140 and into a transfer nip 156 with a transfer subsystem 50 and past cleaning system 200 during a single revolution.

In the embodiment of FIGS. 5, 6 and 7, electrostatic imaging member 112 has a photoreceptor 114. Photoreceptor 114 includes a photoconductive layer formed on an electrically conductive substrate. The photoconductive layer is an insulator in the substantial absence of light so that initial differences of potential Vi can be retained on its surface. Upon exposure to light, the charge of the photoreceptor in the exposed area is dissipated in whole or in part as a function of the amount of the exposure. In various embodiments, photoreceptor 114 is part of, or disposed over, the surface of electrostatic imaging member 112. Photoreceptor layers can include a homogeneous layer of a single material such as vitreous selenium or a composite layer containing a photoconductor and another material. Photoreceptor layers can also contain multiple layers.

Charging subsystem 120 is configured as is known in the art, to apply charge to photoreceptor 114. The charge applied by charging subsystem 120 creates a generally uniform initial difference of potential Vi relative to ground. The initial difference of potential Vi has a first polarity which can, for example, be a negative polarity. Here, charging subsystem 120 has a charging subsystem housing 128 within which a charging grid 126 is located. Grid 126 is driven by a power source (not shown) to charge photoreceptor 114. Other charging systems can also be used.

To provide generally uniform initial differences of potential, charging grid 126 is positioned within a narrow range of charging distances from electrostatic imaging member 112. Grid 126 in turn is positioned by housing 128, thus housing 128 in turn is positioned within the narrow range of charging distances from electrostatic imaging member 112. In this regard, both electrostatic imaging member 112 and housing 128 are joined to a frame 108 in a manner that allows such precise positioning. Frame 108 can comprise any form of mechanical structure to which charging subsystem and electrostatic imaging member 112 can be joined in a controlled positional relationship at least for printing operations. Frame 108 can comprise a unitary structure or an assembly of individual structures as is known in the art. In certain embodiments, during maintenance operations, it can be useful to allow housing 128 to be joined to frame 108 in a manner that can be to be moved in a controllable fashion from the controlled positional relationship used for charging to a maintenance position. Frame 108 can support other components of printing module 48 including writing subsystem 130, development station 140 and transfer subsystem 50.

As is also shown in FIGS. 5, 6 and 7, in this embodiment, an optional meter 129 is provided that measures the electrostatic charge on photoreceptor 114 after initial charging and that provides feedback to, in this example, printer controller 82, allowing printer controller 82 to send signals to adjust settings of the charging subsystem 120 to help charging subsystem 120 to operate in a manner that creates a desired initial difference of potential Vi on photoreceptor 114. In other embodiments, a local controller or analog feedback circuit or the like can be used for this purpose.

Writing subsystem 130 is provided having a writer 132 that forms patterns of differences of potential on an electrostatic imaging member 112. In this embodiment, this is done by exposing electrostatic imaging member 112 to electromagnetic or other radiation that is modulated according to color separation image data to form a latent electrostatic image (e.g., of a color separation corresponding to the color of toner deposited at printing module 48) and that causes electrostatic imaging member 112 to have a pattern of image modulated differences of potential at engine pixel location thereon. Writing subsystem 130 creates the differences of potential at engine pixel locations on electrostatic imaging member 112 in accordance with information or instructions provided by any of printer controller 82, color separation image processor 104 and half-tone processor 106 as is known in the art.

Another meter 134 is optionally provided in this embodiment and measures charge within a non-image test patch area of photoreceptor 114 after the photoreceptor 114 has been exposed to writer 132 to provide feedback related to differences of potential created using writer 132 and photoreceptor 114. Other meters and components (not shown) can be included to monitor and provide feedback regarding the operation of other systems described herein so that appropriate control can be provided.

Development station 140 has a toning shell 142 that provides a developer having a charged toner 158 near electrostatic imaging member 112. Development station 140 also has a supply system 146 for providing the charged toner 158 to toning shell 142 and supply system 146 can be of any design that maintains or that provides appropriate levels of charged toner 158 at toning shell 142 during development. Often supply system 146 charges toner 158 using a technique known as tribocharging in which toner 158 and a carrier are mixed. During this mixing process abrasive contact between toner 158 and the carrier can cause small particles of toner 158 and materials such as coatings that are applied to the toner 158 to separate from the toner. These small particles can migrate to the electrostatic imaging member 112 during development to form at least some of residual material on electrostatic imaging member 112.

Development station 140 also has a power supply 150 for providing a bias for toning shell 142. Power supply 150 can be of any design that can maintain the bias described herein. In the embodiment illustrated here, power supply 150 is shown optionally connected to printer controller 82 which can be used to control the operation of power supply 150.

The bias at toning shell 142 creates a development difference of potential VDEV relative to ground. The development difference of potential VDEV forms a net development difference of potential between toning shell 142 and individual engine pixel locations on electrostatic imaging member 112. Toner 158 develops at individual engine pixel locations as a function of net development difference of potential. Such development produces a toner image 25 on electrostatic imaging member 112 having toner quantities associated with the engine pixel locations that correspond to the engine pixel levels for the engine pixel locations.

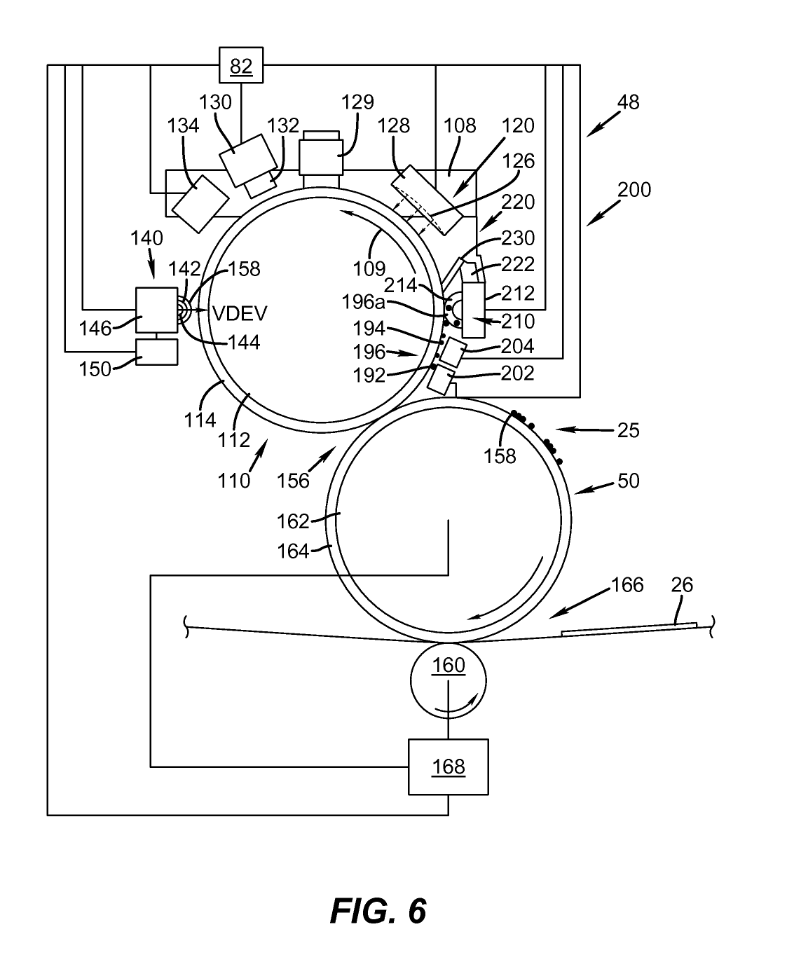

As is shown in FIG. 6, after a toner image 25 is formed, rotation of electrostatic imaging member 112 causes toner image 25 to move through a first transfer nip 156 between electrostatic imaging member 112 and a transfer subsystem 50. In this embodiment, transfer subsystem 50 has an intermediate transfer member 162 that receives toner image 25 at first transfer nip 156. As is also shown in FIG. 6, a substantial portion of the toner 158 used in forming toner image 25 transfers to transfer sub-system 50. However a residual amount 192 of particles of toner 158 from toner image 25 remains on electrostatic imaging member 112. Further, other residual material 194 can be attracted to electrostatic imaging member 112 to form a layer or film thereon. Examples of such other residual material can include but is not limited to additives and coatings applied to the toner, agglomerates, carrier, paper fibers, dirt, dust and other particles that are attracted by a charged surface such as electrostatic imaging member 112. Collectively such residual material 196 advances with electrostatic imaging member 112 as it rotates away from transfer nip 156 and into cleaning system 200.

In the embodiment that is illustrated in FIGS. 5, 6, and 7, electrostatic imaging member 112 carries residual material 196 away from electrostatic imaging member 112 and past a pre-cleaning charger 202 and a charge eraser 204. Pre-cleaning charger 202 applies a charge to the surface of electrostatic imaging member 112 to facilitate removal of residual material 196 while charge eraser 204 acts to cause any residual difference of potential on electrostatic imaging member 112 to be discharged in preparation for the next writing operation.

As is also shown in FIG. 6, after electrostatic imaging member 112 passes charge eraser 204, electrostatic imaging member 112 reaches a first cleaner 210. In the embodiment that is illustrated in FIG. 6, first cleaner 210 has a first cleaner housing 212 that positions and provides a partial enclosure around a brush system 214 that rotates against electrostatic imaging member 112 and that is electrically biased so as to draw a first portion 196a of residual material 196 from electrostatic imaging member 112. Such a brush type embodiment of first cleaner 210 is recognized as being generally effective at removing residual toner particles 192 from electrostatic imaging member 112 and may remove some of the other residual material 194. Alternatively other cleaning systems known in the art can be used for first cleaner 210.

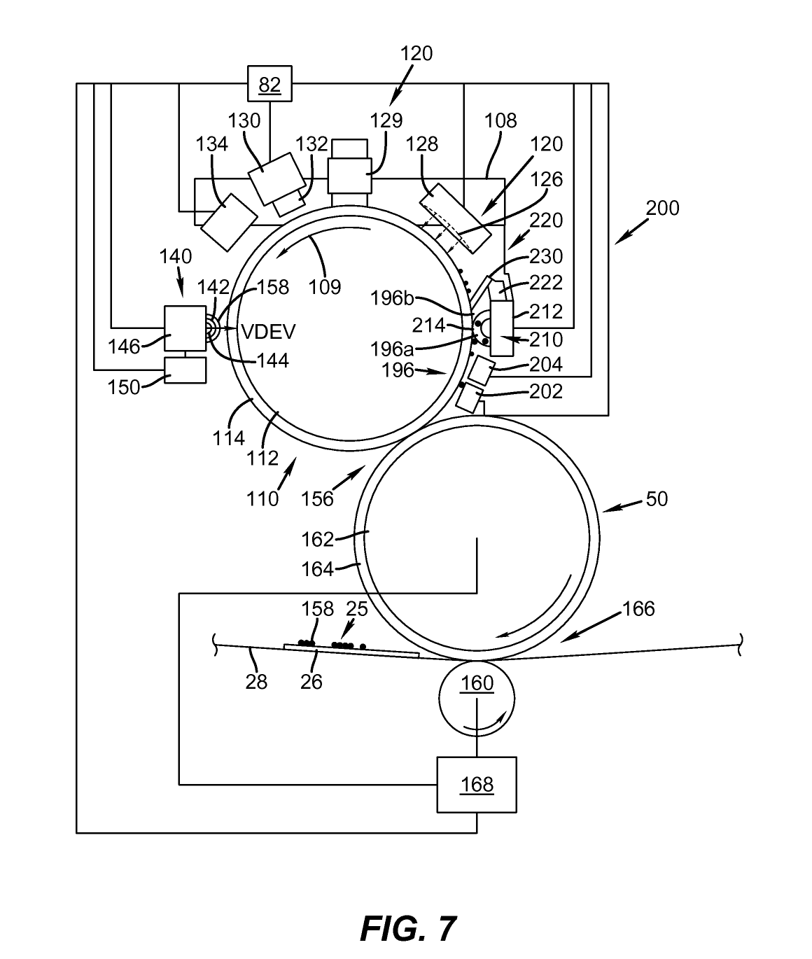

As is illustrated in FIG. 7 after electrostatic imaging member 112 rotates past first cleaner 210, at least a second portion 196b of residual material 196 remains on electrostatic imaging member 112. As shown here, second portion 196b typically includes other residual material 194; however, in some instances second portion 196b can include toner 158. As is also shown in FIG. 7 further rotation of electrostatic imaging member 112 advances second portion 196b of residual material 196 to a scraper cleaning system 220.

FIG. 8 shows a scraper cleaning system 220 in greater detail. As is shown in FIG. 8, in this embodiment, scraper cleaning system 220 comprises a mounting 222 joined to frame 108 to which electrostatic imaging member 112 is also mounted and a scraper 230. Here, mounting 222 is joined to frame 108 by way of a first cleaner housing 212 of first cleaner 210. First cleaner 210 is precisely located relative to electrostatic imaging member 112 and as is illustrated here, this precise relationship takes the form of positioning first cleaner housing 212 at a cleaning distance 125 that is within a range of cleaning distances 123 between a far distance 127 from electrostatic imaging member 112 and at a near distance 129 to electrostatic imaging member 112.

In one non-limiting example, the far distance 127, for example, can be as far as about 125 um greater than a nominal cleaning distance shown here as cleaning distance 125 while the near distance 129 can be about 125 um less than a nominal cleaning distance shown here as cleaning distance 125 to provide a range of cleaning distances 123 that is about 250 um. Other ranges are possible and the amount of variation need not be symmetric about such a nominal cleaning distance 125.

Accordingly, as is shown in greater detail in FIG. 8, by fixing mounting 222 to brush cleaner housing 212 of charging subsystem 120 it becomes possible to position mounting 222 at a mounting distance 225 that is based upon cleaning distance 125 and that is controlled to be within a range of mounting distances 223 that is generally equal to the range of cleaning distances 123. This arrangement enables a mounting 222 to be positioned within a range of mounting distances 223 that is between about 125 um greater than or 125 um less than a determined distance from electrostatic imaging member 112. In this example, mounting distance 225 is illustrated as being measured along a lower edge of mounting 222. However, this is not critical and other points on mounting 222 can be used for such a measurement.

Mounting 222 positions a first end 232 of scraper 230 at a holding angle 224 so that an extending portion of scraper 230 extends across an extension distance 240 from mounting 222 to electrostatic imaging member 112. The holding angle 224 can be in a range between for example 20 to 30 degrees. Extension distance 240 is measured along holding angle 224 and is shown here, in phantom the free length 236 of an non-deflected scraper 230 extends from a position where mounting 222 ceases to hold scraper 230′ to second end 234 of an undeflected scraper 230.

As is shown in FIG. 8, when mounting 222 is positioned at a mounting distance 225, free length 236 exceeds extension distance 240 and second end 234 of scraper 230 is resiliently deflected by an extent of deflection 237 that allows free length 236 to fit within extension distance 240. It will be appreciated that the extent of deflection 237 is determined based upon the holding angle 224, the engagement distance 243 and the free length 236 of scraper 230. Deflection 237 causes second end 234 of scraper 230 to bend to contact electrostatic imaging member 112 at a working angle 242.

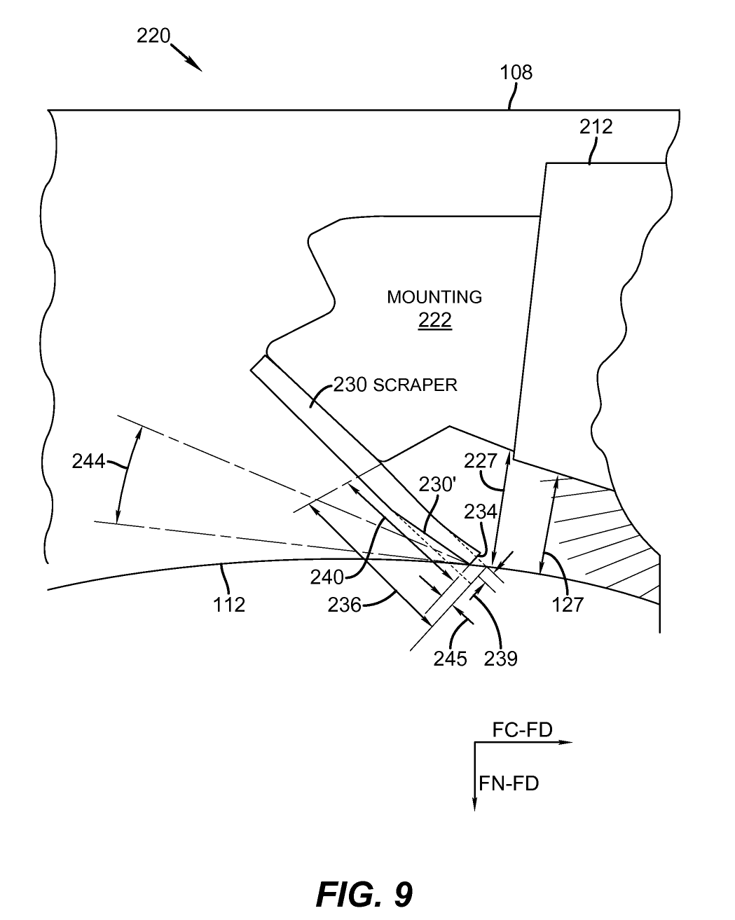

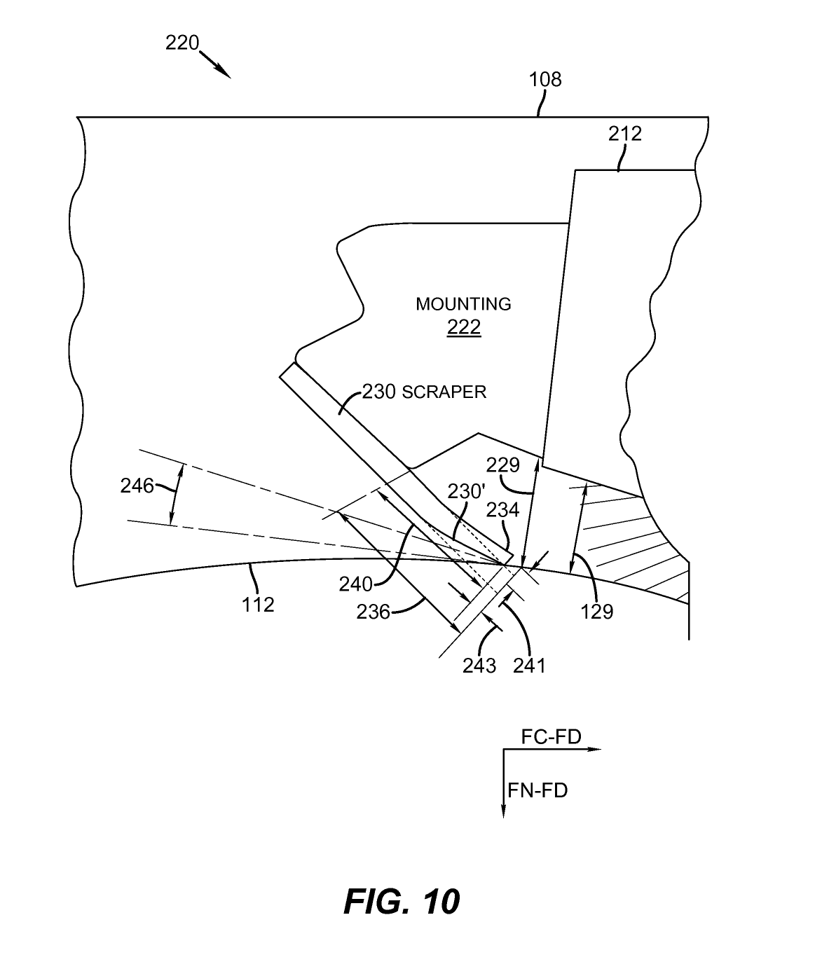

As will be discussed in greater detail below with respect to FIGS. 9 and 10, extension distance 240 can have a significant impact a working angles 242 of scraper 230. However, extension distance 240 can vary within a range 238 of extension distances that is determined according the range of mounting distances 223 which, in turn, is based on the relationship of the location of mounting 222 and the electrophotographic imaging member 112.

FIG. 9 shows the embodiment of FIG. 8 with first cleaner housing 212 positioned at the far distance 127. As is shown in FIG. 9, when first cleaner housing 212 is at far distance 127, mounting 222 can also be at a far distance 227 from electrostatic imaging member 112. This change from the arrangement of FIG. 8 lengthens extension distance 240 while the free length 236 remains the same, and creates a reduced engagement distance 243. These changes create a far distance deflection 239 of scraper 230 at second end 234 that is less than the deflection when first cleaner housing 212 is at cleaning distance 125. This forms a far distance working angle 244 that is greater than the working angle 242 shown in FIG. 8. This yields a far distance cleaning force FC-FD and a far distance normal force FN-FD. As is further shown in FIG. 9, the far distance cleaning force FC-FD is proportionately greater than the far distance normal force FN-FD as described with reference to FIG. 8.

In contrast, as is shown in FIG. 10, when first cleaner housing 212 is at the near distance 129, extension distance 240 is reduced while the free length 236 remains the same. This change from the arrangement shown in FIG. 8 creates an increased engagement distance 245, which creates a near distance deflection 241 of scraper 230. Near distance deflection 241 is greater than deflection 237 shown in FIG. 8 and scraper 230 bends to form a near distance working angle 246 that is less than the working angle 242 shown in FIG. 8. This near distance working angle 246 yields a near distance cleaning force FC-ND that is more proportional a near distance normal force FN-ND than the cleaning force FC is to the normal force FN-FD as occurs when the mounting is positioned as is shown in FIG. 8.

It will be appreciated from this that by positioning mounting 222 on a component of the printing module 48 that, for reasons that are integral to the function of that component, is be precisely positioned with respect to electrostatic imaging member 112 it becomes possible to provide a scraper 230 that has a more controlled range of working angles. Because scraper 230 can be positioned within such a controlled range of positions, there is a reduced need to cause scraper 230 to have a free length 236 that is sufficient to maintain engagement with electrostatic imaging member 112 across a large range of variability of engagement distances 243 and a more precise range of working angles 242 can be provided.

Accordingly, by positioning scraper 230 using a reference structure that has a precise positional relationship with the electrostatic imaging member 112, it is possible to achieve a range of working angles that are greater than the working angles of an alternative range of working angles if the scraper 230 were to be positioned within an alternative range (not shown) of extension distances that is greater than the range 238 of extension distances 240. This, in turn, allows scraper 230 to provide a cleaning force FC that has a desired range of ratios to the normal force FN thus providing greater cleaning efficiency while also lowering friction and the attendant difficulties associated with higher levels of normal force FN. Such outcomes are impractical to achieve and maintain in systems where there is less control of the positional relationship between mounting 272 and electrostatic imaging member 112 as occurs where an alternative range of positional relationships is used such as one that is not fixed a reference structure that has a precise positional relationship with the electrostatic imaging member as is generally described herein. In the embodiment show in FIGS. 6-10, embodiment, first cleaner housing 212 has such a precise relationship. In another non-limiting embodiment a component that can have such a precise relationship can be development station 140 or a charging subsystem 120 which are also generally precisely located relative to electrostatic imaging member 112. In other embodiments, mounting 222 can be directly supported by frame 108. In sum, a scraper cleaning system 220 provides advantageous ratios of cleaning force FC to normal force FN on the order of those found in scraping systems and does so with reduced the risks of catastrophic failure associated with prior art scraping systems including but not limited to the risks of creating a high the high normal forces associated with prior art scraping systems.

Scraper 230 can be formed from any of a variety of materials. These can include materials such as polyurethane, polycarbonate, acetal, phosphor, bronze, and stainless steel. In one embodiment scraper 230 can be a polyester polyurethane having a thickness between about 0.8 and about 1.2 mm and a Shore A durometer measurement between about 80 and 90 with a free length 236 between about 8 and 12 min long. In such an embodiment an engagement distance of between about 1 mm to 1.5 mm can be used. Scraper 230 can be coated in whole or in part to add strength, stiffness or to otherwise adjust properties as required. For example a scraper 230 can be coated with a submicron Polymethyl Methacrylate powder dispersed on the second end 234. When such a powder is applied to second end 234 of a scraper 230 having a Shore A between 80-90, there can be a reduction in tuck under risk. However, it will be appreciated that with greater control of the ratio of normal forces and cleaning forces by virtue of better control of the geometric positioning of the scraper, it becomes possible to form a scraper made using a wider range of materials.

In the embodiment that is illustrated in FIGS. 5-10, mounting 222 has been shown as a unitary component separate from first cleaner housing 212 and scraper 230. In other embodiments, mounting 222 can be made integral to housing 128 or integral to scraper 230. Mounting 222 can comprise a single component or a combination of components. In certain embodiments, mounting 222 can comprise interface components that enable mounting 222 to engage either first cleaner housing 212 or scraper 230 in a manner to that help to achieve the results described herein. For example, mounting 230 can provide fasteners, engagement pins, mounting structures, mounting structures for fasteners, embossments, magnetic, electrical optical or other alignment features to help ensure a desired alignment or to ensure engagements between mounting 222 and housing 138 or mounting 222 and first cleaner housing 212 with reduced possibility of positional misalignment, or to provide vibration or wear reduction protection.

As is shown in FIG. 11, in another embodiment, an optional trap system 270 is provided having a trap surface 272 adhered to a collection surface 273 of a catch tray. This trap surface 272 extends between catch tray 274 and electrostatic imaging member 112 and redirects residual material 196 that is separated from electrostatic imaging member 112 into catch tray 274 and serves to reduce or to substantially prevent any of such residual material 196 from falling into the area of the pre-cleaning charger 202 and charge eraser 204. The trap surface 272 can take the form of, for example, a sub-millimeter thickness polymer materials including but not limited to a 0.5 mm thickness strip of biaxially-oriented polyethylene terephthalate which when engaged with the electrostatic imaging member 112 induces very low drag force. When the trap surface 272 is engaged with the electrostatic imaging member 112, the trap surface 272 is deflected to a position near parallel with the surface of the primary imaging member. This is so trap surface 272 does not act like a scraper or wiper but instead allows any residual material on the electrostatic imaging member 112 to move freely underneath trap surface 272.

In one embodiment, trap surface 272 and optionally catch tray 274 are installed and can be removed from a printing module 48 by a sliding action from one side or the other of the electrostatic imaging member 112. As is illustrated in FIG. 12, to facilitate sliding insertion, sloping surfaces 276 and 278 are provided at an insertion end 280 of trap surface 272 and, optionally, catch tray 274. This enables trap surface 272 and catch tray 274 to slide into the print engine 48 without stubbing on the electrostatic imaging member 112.

FIG. 13 shows yet another embodiment with a scraper cleaning system 220 having a mounting 222 with a scraper 230 and a positioner 290 therebetween. As is shown in FIG. 13 positioner 290 is joined to scraper 230 and is mounted onto mounting 222 using a fastener 292. Mounting 222 and positioner 290 cooperate to position scraper 230 at the holding angle 224. In this regard, the shape and size and way in which scraper 230, mounting 222 and positioner 290 are joined together can be managed to influence the holding angle and extension distance 240 of scraper 230. For example, in the embodiment that is illustrated in FIG. 13, positioner 290 is wedge shaped and is sized and shaped to adjust both holding angle 224 and extension distance 240.

In other embodiments positioner 290 can be shaped or sized primarily to impact the extension distance, while in other embodiments positioner 290 can be shaped and sized to impact the holding angle. In still other embodiments positioned 290 can have mounting features that hold or otherwise help to define the position of scraper 230 so as to define at least in part the holding angle 224 or the extension distance 240. Where a positioner 290 is used, the extension distance 240 can be determined based upon a distance from positioner 290 to electrostatic imaging surface 112.

It will be appreciated from this that different sizes or shapes of positioner 290 made available for use with the same mounting 222 in order to provide a manufacturer of or repair facility with an opportunity to further reduce the amount of variability of holding angle 224 or extension distance 240.

In FIG. 13, a positioner 290 is joined to mounting 222 and to scraper 230 by way of fastener 292 joined to mounting 222. Further, positioner 290 can also optionally be joined to mounting 222 by way of a secondary fastener (not shown) or an adhesive or by other conventional methods for joining such structures so that positioner 290 will remain joined to mounting 222 even in the event that fastener 292 is removed, for example to allow cleaning or replacement of scraper 230. This can be done where, for example, it is desired that the scraper 230 be replaceable by an operator of the machine but where there is also a desire to ensure that a positioner 290 that has been carefully selected, installed and tested to ensure that it provides exact positioning of a scraper 230 will not be unnecessarily removed or potentially damaged during scraper 230 maintenance.

In certain embodiments, positioner 290 can also be used to provide features such as mountings, snaps, clips, magnetic surfaces or other structures that can allow a scraper 230 to be provided without mounting features of the type required to enable scraper 230 to be directly mounted to mounting 222. This simplifies the process of fabricating a scraper 230.

The invention has been described in detail with particular reference to certain preferred embodiments thereof, but it will be understood that variations and modifications can be effected within the scope of the invention

What is claimed is:

1. A cleaning system for an electrostatic imaging member, the cleaning system comprising:
a scraper;
a mounting holding the scraper so that an free length of the scraper extends from the mounting;
a frame positioning the mounting relative to the electrostatic imaging member so that the scraper extends along a holding angle toward the electrostatic imaging member and so that the mounting is separated from the electrostatic imaging member by an extension distance along the holding angle that is less than the free length with the scraper resiliently deflecting to fit within the extension distance to define a working angle where the scraper contacts the electrostatic imaging member;
wherein the extension distance is within a range of extension distances that cause the scraper to have a working angle that is within a range of working angles are greater than the working angles of an alternative range of working angles if the scraper were to be positioned within an alternative range of extension distances that is greater than the range of extension distances.

2. The cleaning system of claim 1, wherein the frame is used to position a component of a printing module within a range of component distances from the electrostatic imaging member and wherein a mounting is joined to the component to position the scraper within the range of extension distances from the electrostatic imaging member and wherein the range of extension distances is within the range of component.

3. The cleaning system of claim 1, wherein the scraper creates normal forces in proportion to cleaning forces as a function of the working angle and wherein the extension distance is within a range of extension distances that cause the scraper to provide a cleaning force along the electrostatic imaging member while also providing a normal force against the electrostatic imaging member that is within a range of normal forces that is less than an alternative range of normal forces that would be created by the scraper if the scraper were to be used to provide the cleaning force with the scraper positioned within an alternative range of extension distances that is greater than the range of extension distances.

4. The cleaning system of claim 1, wherein the working angle is between about 20 to 30 degrees.

5. The cleaning system of claim 1, wherein holding angle is between 20 and 25 degrees.

6. The cleaning system of claim 1, further comprising a first cleaning system adapted to apply cleaning force to the electrostatic imaging member to remove one portion of the residual material from the electrostatic imaging member and the scraper removes another portion of the residual material from the wiper.

7. The cleaning system of claim 1, wherein the holding angle is between about 22 and 25 degrees.

8. The cleaning system of claim 1, further comprising a trap system having a trap surface that extends between a collection surface of a catch tray to collect residual material that is separated from the electrostatic imaging member.

9. The cleaning system of claim 1, further comprising a positioner between the mounting and the scraper.

10. The cleaning system of claim 1, further comprising a positioner between the mounting and the scraper shaped to in part determine at least one of a holding angle and a extension distance.

11. The cleaning system of claim 1, wherein the positioner is joined to the mounting and the scraper is fastened to the mounting with the positioner therebetween.

12. A printer comprising:
a printing module comprising an electrostatic imaging member;
a charging subsystem for creating a generally uniform pattern of differences of potential on an electrostatic imaging member;
a writing system for forming a pattern of differences of potential at pixel locations on the electrostatic imaging member according to a pattern of toner to be formed on the electrostatic imaging member with the differences of potential capable of attracting residual materials to the electrostatic imaging member;
a development station providing charged toner and a development potential that causes the charged toner to develop on the electrostatic imaging member according to the differences of potential;
a transfer system providing a surface onto which a substantial portion of the toner on the electrostatic imaging member is transferred for subsequent transfer onto a receiver;
an first cleaner applying cleaning forces to remove residual material including toner from the electrostatic imaging member
a cleaning system with a mounting holding a scraper so that a free length of the scraper extends from the mounting toward the electrostatic imaging member;
a frame positioning the mounting relative to the electrostatic imaging member so that the scraper extends along a holding angle toward the electrostatic imaging member and so that the mounting is separated from the electrostatic imaging member by an extension distance along the holding angle that is less than the free length with the scraper resiliently deflecting to fit within the extension distance to define a working angle between the scraper and the electrostatic imaging member;
wherein the extension distance is within a range of extension distances that cause the scraper to provide a cleaning force along the electrostatic imaging surface to remove residual toner and other residual materials from the electrostatic imaging member while also providing a normal force against electrostatic imaging member that is within a range of normal forces that is less than an alternative range of normal forces that would be created by the scraper if the scraper were to be used to provide the cleaning force with the scraper positioned within an alternative range of extension distances that is greater than the range of extension distances.

13. The printer of claim 12, wherein the extension distance is within a range of extension distances that cause the scraper to have a working angle between the scraper and the electrostatic imaging surface that is within a range of working angles that are less than an alternative range of working angles if the scraper were to be positioned within an alternative range of extension distances that is greater than the range of extension distances and wherein the scraper creates normal forces in proportion to cleaning forces as a function of the working angle.

14. The printer of claim 12, further comprising a trap system having a trap surface that extends between a collection surface of a catch tray to collect residual material that is separated from the electrostatic imaging member.

15. The printer of claim 12, wherein the collection surface deflects against the electrostatic imaging member in a direction of movement of the electrostatic imaging member and at an angle that is substantially parallel to the electrostatic imaging member.

16. The cleaning system of claim 12, wherein the frame is used to position a component of a printing module within a range of distances from the electrostatic imaging member and wherein a mounting is joined to the component to position the scraper within the range of working distances from the electrostatic imaging member and wherein the range of working distances is within the range of extension distances relative to the electrostatic imaging member.

17. The printer of claim 12, wherein the scraper creates normal forces in proportion to cleaning forces as a function of the working angle and wherein the extension distance is within a range of extension distances that cause the scraper to provide a cleaning force along the electrostatic imaging surface while also providing a normal force against the electrostatic imaging surface that is within a range of normal forces that is less than an alternative range of normal forces that would be created by the scraper if the scraper were to be used to provide the cleaning force with the scraper positioned within an alternative range of extension distances that is greater than the range of extension distances.

18. The printer of claim 12, further comprising a positioner between the mounting and the scraper.

19. The printer of claim 1, further comprising a positioner between the mounting and the scraper shaped to in part determine at least one of a holding angle and a extension distance.

20. The printer of claim 1, wherein the positioner is joined to the mounting and the scraper is fastened to the mounting with the positioner therebetween.
